(19) United States
(12) Patent Application Publication
(10) Pub. No.: US 2008/0093357 A1
(43) Pub. Date: Apr. 24, 2008

(54) Neonatal Nutrition Warmer

(76) Inventors: Scott A. Norman, Overland Park, KS (US); Mark A. Petheram, Overland Park, KS (US); Drake L. Koch, Kansas City, MO (US); Janice M. Shields, Kaanapali maui, HI (US); Paul W. Shields, Kaanapali maui, HI (US)

Correspondence Address: SHUGHART THOMSON & KILROY, PC, 120 WEST 12TH STREET, KANSAS CITY, MO, 64105, US

(21) Appl. No.: 11/849,041

(22) Filed: Aug. 31, 2007

Related U.S. Application Data
(60) Provisional application No. 60/851,936, filed on Oct. 16, 2006.

(51) Int. Cl. A47J 36/24; B65D 33/16; B65D 33/34

(52) U.S. Cl. 219/521; 383/5; 383/99

(57) ABSTRACT

A heating device for individually and automatically warming and vibrating one or more containers to thaw, warm, and mix a liquid within the containers, the liquid being cold or frozen. The device heats the contents of each container to a selected temperature by heat exchange between a heated fluid and the contents of the container. A bag or liner holds the fluid to be heated and the container thereby allowing the bag or liner to be placed into a device well or reservoir for heating while vibrating or shaking elements connected to the well or reservoir assist in mixing and uniformly heating the fluid and the container contents. The container typically is a baby bottle, syringe, test tube, or the like.

### CROSS REFERENCE TO RELATED APPLICATION

This application claims priority under 35 U.S.C. 119(e) and 37 C.F.R. 1.78(a)(4) based upon copending U.S. patent application Ser. No. 11/801,142 for Neonatal Nutrition Warmer filed May 9, 2007 and to copending U.S. Provisional Application Ser. No. 60/851,936 for Warmer and Cooler for Bottled Liquid filed Oct. 16, 2006.

### FIELD OF THE INVENTION

The present invention relates to devices for heating fluids, in particular, the present invention provides transmission of heat and vibration to a first fluid for even transmission of heat to a nutritional solution for neonates. In particular, the invention relates to a novel heating device and heat transfer fluid container for warming neonate nutrition, for example, breast milk in a quick, reliable and automated manner. More particularly, the embodiments of the device provide a means, generally in the form of a bag-like container, for maintaining security over the nutritional solution during storage and warming and other preparation procedures and for isolating the nutritional solution from contaminates during storing and warming and preparing of the solution and for keeping isolated from the warming device the fluid used to disperse and make uniform the application of heat to the nutritional solution. Several collar embodiments are provided to maintain separation of the nutrition-holding container from the heat transmission fluid to thereby avoid contamination of the container opening by avoiding it contacting the heat transmission fluid.

### BACKGROUND OF THE INVENTION

In general, devices for warming fluid containers have been used extensively in the prior art. Until the development of the device shown in U.S. Pat. No. 6,417,4987 (incorporated herein by reference) no suitable devices have been available for use in warming baby bottles in neonatal intensive care units (NICU) of a hospital. NICU are responsible, among many other things, for administering substrate, formula, or breast milk to newborn infants. Medical studies reinforce the fact that newborns benefit significantly from receiving colostrum—the first milk of the mother after giving birth. Colostrum is known to supply extremely high concentrations of antibodies essential to the development of a newborn's immune system, and is also thought to aid in establishing digestion of the newborn. Accordingly, it is absolutely critical to capture the colostrum from the mother and carefully preserve it for later administration to the newborn as quickly, cleanly, and safely as possible.

In current practice, NICU nurses capture breast milk from the mother in baby bottles, refrigerate or freeze the breast milk, rewarm the breast milk, and feed it to the newborn. Newborns tend to feed about eight times per day, which necessitates frequent thawing, warming, and administering of breast milk. This frequent and time consuming process wastes an enormous amount of time for the NICU nurses, especially due to the manually intensive method of thawing and warming the breast milk. Using a microwave to warm the breast milk is not a viable option since such a process has a detrimental effect on the quality of the breast milk.

Instead, the breast milk is thawed and warmed by placing the baby bottle into a large insulated cup full of hot tap water. Due to simple heat transfer principles, the hot water quickly cools down even before the breast milk has had a chance to thaw, much less warm up to body temperature. Therefore, NICU nurses must repeatedly add hot water to the insulated cup in order to thaw and warm the breast milk. As such, NICU nurses waste precious time maintaining an archaic warming process instead of attending to newborns. In the alternative, NICU nurses sometimes leave the insulated cup and baby bottle under a faucet of running hot water. Unfortunately, this approach works, for only one bottle at a time and, if left unattended, results in a temporary depletion of hot water supply or possibly overheated breast milk.

There are other problems with the insulated cup warming process. For one, since the method is entirely manual and subjective, it is possible that the temperature of the breast milk is inadequately warmed and is either too cold or too hot. Additionally, it is important that the bottle be shaken to agitate and properly mix the breast milk; however, because of the often hurried pace of an NICU and the manual nature of the warming process the baby bottles are not always adequately shaken. Finally, the current warming process results in a mess of half full insulated cups lying about on NICU counter tops that often times are inadvertently knocked over, creating an even bigger mess and an aura of untidiness.

The prior art has suggested use of heated bath immersion devices. For example, one complicated apparatus in effect accomplishes the same result as the insulated cup/running tap water process mentioned above. U.S. Pat. No. 4,597,435 to Fosco, Jr. teaches a bottle warmer that uses a thermal transfer fluid to heat a baby feeding bottle. Fosco, Jr. discloses a portable device having an open top cup-like container for holding hot water therein. A removable platform is positioned within the container for suspending a baby bottle inside the container in contact with the hot water. The removable platform separates the container into an upper and lower chamber. An open-ended tube extends from the top of the container down into the lower chamber for conveying incoming tap water thereto. Accordingly, the portable device is placed under a faucet dispensing running hot water such that the hot water is directed down into the open-ended tube. The hot water thus enters the lower chamber and is forced under pressure up around the sides of the suspended baby bottle and into the upper chamber until it exits via the open top of the container. Obviously, the Fosco, Jr. warmer provides an unnecessarily complex apparatus for bottle warming that, in effect, is substantially similar to the insulated cup method that NICU nurses currently use. Therefore, Fosco, Jr. does not address, much less solve, the above-mentioned problems. Furthermore, the background section of Fosco, Jr. discusses the shortcomings of several other receptacle-type devices that need not be further explored here.

Additionally, the prior art has suggested use of dry block heaters for heating test tubes. Dry block designs typically use metal blocks having a central or localized heating passage therethrough. A series of tube wells are typically arranged in a pattern within the metal block in close proximity to the heating passage. Heat flowing through the heating passage transfers through the block, into the tube wells, and into test tubes placed in the tube wells. This design has one significant drawback in particular. The tube wells are of a necessarily fixed diameter to accept a slightly undersized test tube, thereby establishing a close fitting relationship between the metal block and test tubes to enable effective heat transfer therebetween. Unfortunately, this configuration is not flexible enough to permit use of a variety of sizes of test tubes with a particular block. Therefore, only one size of test tube, or baby bottle, could be used with such a device. Since different NICU inevitably use bottles from different manufacturers that are of different sizes and shapes, this type of fixed block design is not practical for the purposes intended according to the present invention.

With respect to the device shown in U.S. Pat. No. 6,417,498 a drawback is found even in this advance device. The repeated use of the same heat transferring fluid in the wells of the device can lead to bacterial growth in the wells and in the heat transferring fluid. When such bacterial growth takes place it is ill-advised to insert the neonate formula container therein as this would assist in the transmission of bacteria to mother and child. The options is to constantly change heat transferring fluid and/or to repeated clean the wells and the surface of the device during use. Such a cleaning regimen is inconvenient in a busy hospital and can be neglected. Therefore it would be a benefit if a means were available of isolating the heat transferring fluid from the wells and of isolating the heat transferring fluid from the opening of the neonate formula container. It would be a further benefit if such a means avoided repeated emptying and filling of the heat transmitting fluid and permitted the neonate formula container to be secured from tampering during the storage and warming stages of use.

From the above, it can be appreciated that baby bottle warming methods and apparatus of the prior art are not fully optimized. Therefore, what is needed is an automatic bottle-heating device that quickly, accurately, individually, and simultaneously warms and vibrates a multitude of baby bottles so as to adequately heat and mix breast milk contained therein.

### SUMMARY OF THE INVENTION

A warming device for thawing and heating neonate nutrition is provided which has an individual heater unit and individual vibrator unit connected to one or a plurality of wells. The wells receive a flexible bag therein the bag containing a heat transmitting fluid and a container of neonate nutrition—usually breast milk. The wells are heated and vibrated to warm the heat transmitting fluid and the wells are shaken to circulate the heat transmitting fluid to provide even heating and even transmission of heat to the neonate nutrition. The vibrating further circulates the neonate nutrition to distribute the transmitted heat within the neonate nutrition. A collar may be provided for positioning around the container holding the neonate nutrition. The collar maintains the container opening and/or the container closure in a spaced relation above the heat transmitting fluid which also is within the flexible bag. The collar may maintain the spaced relationship between the heat transmitting fluid and the container closure or container opening by providing buoyancy to the container or by the collar contacting the sidewall of the warming device well to thereby be supported by the well and to maintain the container closure and/or container opening above the surface of the heat transmitting fluid.

The foregoing is intended to be illustrative of the invention and is not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention.

### DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 shows a front and left side and top perspective view of an embodiment having four warming wells with bags containing heat transmitting fluid and containers of neonate nutrition situated therein;

FIG. 2 is an exploded and partial fragmentary view of the embodiment of FIG. 1, and showing a void in the housing to receive the well;

FIG. 3 is a fragmentary rear left side and top perspective view of the embodiment of FIG. 1;

FIG. 4 shows an embodiment of a bag for holding heat transmitting fluid with a nutrition container suspended within the bag and heat transmitting fluid by a collar fitted about the container to maintain the container closure in spaced relation above the heat transmitting fluid contained within the bag;

FIG. 5 shows an alternative embodiment of a collar providing similar function to the collar of FIG. 4 and showing the collar of FIG. 5 provided with stand-offs for engaging the sidewalls of the well and with a fold line included in the collar to allow collapsing of the collar within the bag when not in use in holding a container;

FIG. 6 shows yet another alternative embodiment of a collar of the type of embodiments as described in FIGS. 4 and 5;

FIG. 7 shows the collar of FIG. 6 having a neonate formula bottle inserted therein;

FIG. 8 shows the use of the collar of the embodiment of FIG. 6 to support a syringe-type feeding device for neonates to allow warming of the nutritional material within the syringe while maintaining the plunger end of the syringe spaced above the heat transmitting fluid contained within the bag;

FIG. 9 shows an alternative embodiment of bag 16 in which welds 92a,b spot-weld together bag front wall 96a to bag rear wall 96b to provide a stricture within the bag to capture and retain cap 74 between welds 92a,b when container 18 is inserted into bag 16 and passed between welds 92a,b resulting in capture of closure 74 by the stricture created by welds 92a,b;

FIG. 10 is a cross-section view taken along line 10-10 of FIG. 9 and showing the creation of the stricture by welds 92a,b for capture of closure 74 there between;

FIG. 11 is a side elevation view showing an alternate mounting of the securing frame by a screw 42 seated into a tubular support 44;

FIG. 12 shows an alternate structure for heating and cooling well 14a-14d using a peltier thermoelectric module to provide both heating and cooling of the liquid in well 14a-14d;

FIG. 13 shows an embodiment in which a radio frequency identification device having a temperature sensor therein is within the container holding the breast milk or formula;

FIG. 14 shows and embodiment in which an infrared detector is provided for direct temperature readings of the temperature of the breast milk or formula;

FIG. 15 shows and alternate embodiment having an infrared detector for direct temperature readings of the temperature of the breast milk or formula;

FIG. 16 shows an embodiment of a portable warmer pouch that can be wrapped about a container or syringe containing the breast milk or formula;

FIG. 17 shows the warmer pouch of FIG. 16 wrapped about a syringe; and

FIG. 18 shows the warmer pouch of FIG. 16 wrapped about a syringe that is mounted in a metered feeding device.

### DESCRIPTION OF THE PREFERRED EMBODIMENT

As required, detailed embodiments of the present inventions are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

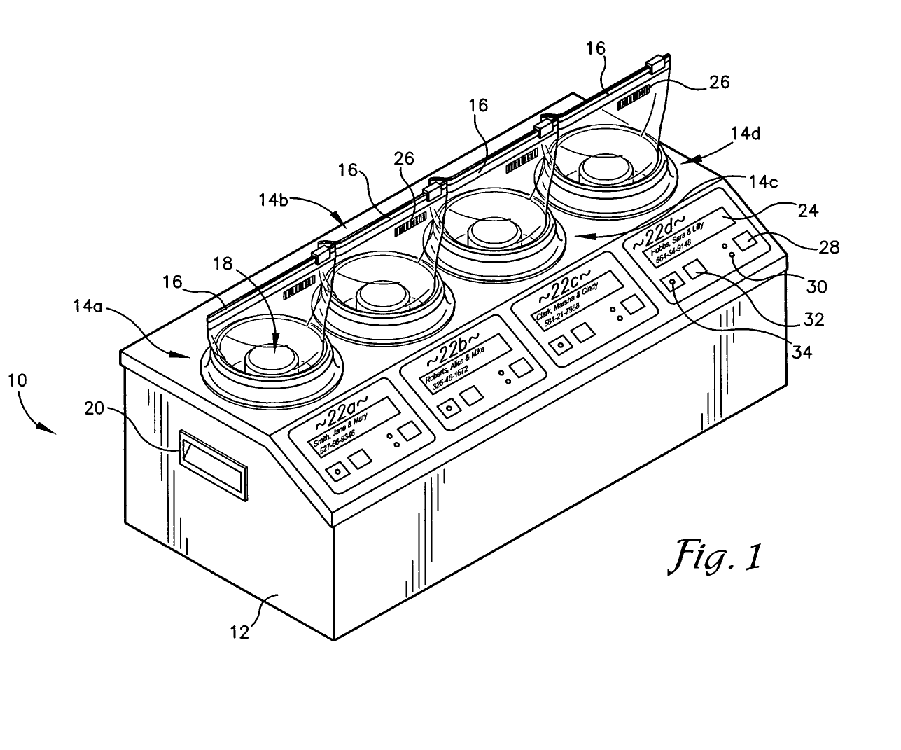

Referring to FIG. 1, an embodiment of the warming device 10 is shown comprising a housing 12 which generally supports a plurality of wells or reservoirs 14a-14d into which may be placed reservoir bags or liners 16. Reservoir bags 16 are utilized to generally hold a container 18 which is filled with a liquid neonate nutritional substance, such as breast milk, that is in need of thawing or warming to a temperature for use. It will be appreciated by those skilled in the art that while a flexible bag is used in the preferred embodiment, that a rigid liner of plastic or other heat transferring material could be used to isolate the heat transfer fluid 58 from the well 14. In general operation, a container 18 having neonate formula or breast milk therein is placed within bag 16 with a heat transfer fluid which previously has been placed into bag 16. Bag 16 is then introduced into well 14 of housing 12 of warming device 10 and heating and/or vibrating or shaking of the well 14 is commenced to achieve warming of the neonate formula or nutritional liquid which is in container 18 within bag 16. With this general description of the operation of the present invention in mind, warming device 10 and bag 16 will be described in greater detail hereinafter.

Still referring to FIG. 1, it may be appreciated that housing 12 is provided with opposed handles 20 (right side handle not shown) and individual control panels 22a-22d which are used to individually control wells or reservoirs 14A-14D. Referring now to the control panel 22d as being representative of control panels 22a-22d, the specifics of each control panel will be described with reference thereto. In control panel 22d, a data display 24 is provided which may display various information regarding the fluid substance within container 18 that is retained within well 14d. For example, the name of the mother and/or child for whom the neonate formula is intended may be displayed on data display 24 as well as a room number or social security number or other identifying information such as an indicia 26 which is used to identify each individual bag 16 and associate each individual bag 16 uniquely with a particular patient or child. Control panel 22d also includes a computer controlled temperature readout display 28 and light emitting diodes (LEDs) 30 to indicate the heating status of the device. As it is beneficial to shake or vibrate each individual well 14 as it is being used to better achieve consistent warming of the heat transmitting fluid and the nutritional formula within container 18, an on/off control 32 for the vibration unit associated with each well 14a-14d also is provided on data display 24. As each of wells of 14a-14d are independently operable, a separate on/off switch 34 is provided to allow for individual control of each of wells 14a-14d.

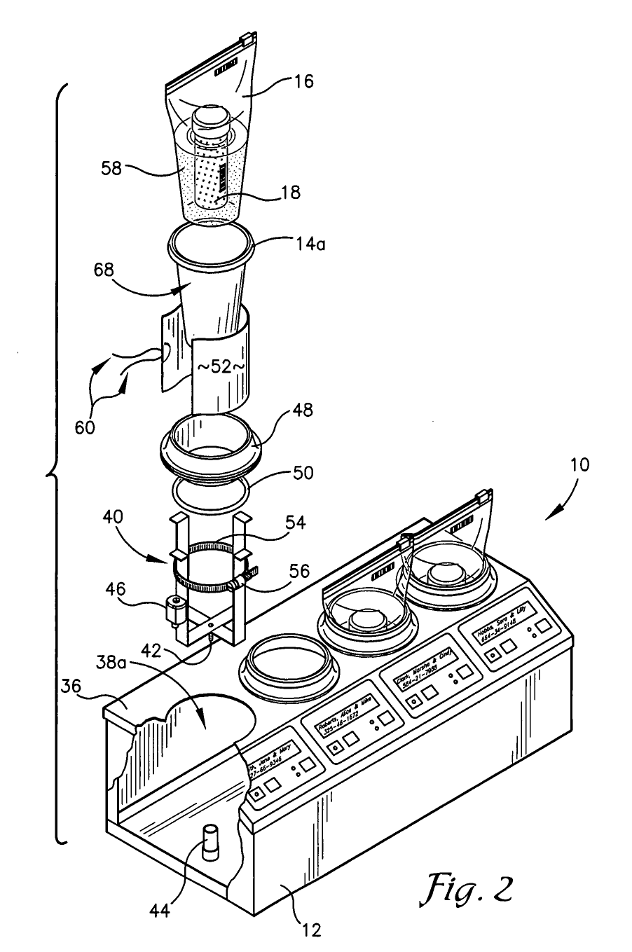

Referring now to FIG. 2, the individual components comprising warmer device 10 and, in particular, each of wells 14a-14d will be described. In the exploded view of FIG. 2, reservoir or well 14a has been separated into its component parts. Housing 12 of warming device 10 on its upper surface 36 is provided with a plurality of voids 38a-38d into which well 14a and its associated components are seated. A securing frame 40 is seated within void 38a with the base of securing frame 40 being attached by a screw 42 to support 44. A shaking or vibrator device 46 is connected to securing frame 40 to provide individually controllable shaking or vibrating of well 14a. Dampening cuff 48 is press fitted and clamped against the rim which defines void 38a in upper surface 36 and stiffening gasket 50 is fitted on dampening cuff 48 to assist in retaining dampening cuff 48 in position on housing 12. Heating unit or heating blanket 52 is positioned about or wrapped about well 14a and heating unit or blanket 52 and reservoir or well 14a is inserted by press fitting heating blanket 52 and well 14a into dampening cuff 48. Once well 14a has been inserted into dampening cuff 48, well 14a may be held in securing frame 40 by compression band 54 which is reduced about securing frame 40 and well 14a using worm gear 56. This connection between securing frame 40 and well 14a assists in the transmission of shaking or vibration from vibrator 46 to provide shaking or movement or mixing of the heat transfer fluid 58 which is contained within bag 16. It will be appreciated that heating unit or heating blanket 52 is provided with power leads 60 which are connected to the power supply (not shown) of device 10. For operation, bag 16 is inserted into well 14a and container 18 and heat transfer fluid 58 are added to bag 16 for transmission of heat from well 14a through heat transfer fluid 58 to the contents of container 18.

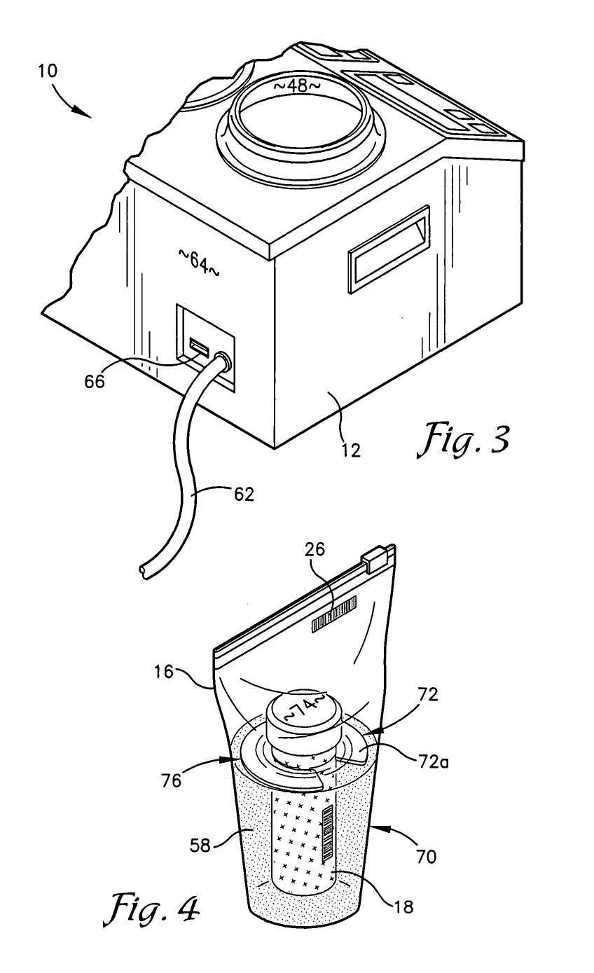

Referring now to FIG. 3, power is provided to warming device 10 by power cord 62 which enters housing 12 at rear wall 64. Adjacent power cord 62 is data port 66 which may be a USB port or other convenient type of data port which can be used to transfer information to/from data display 24 and/or to allow the recording of data related to the operational status of each of wells 14a-14d.

Referring now to FIGS. 4 and 5, the use and operation and structural components of bag 16 will be described in more detail. Bag 16 is used to hold and separate a heat transfer fluid 58 from contact with reservoir or well 14a-14d. Prior devices have relied upon the heat transfer fluid being placed directly into well 14a-14d thus creating a cleaning and sanitary problem within hospitals and nurseries and the like. The use of bag 16 to hold and separate heat transfer fluid 58 from reservoir or well 14a-14d provides the benefit of cleanliness and sanitation which is not achieved by prior art devices. It will be appreciated by those skilled in the art that many liquids, or even heat transmissible solids or particulate solids, could be used to transfer the heat generated by heating unit or heating blanket 52 to well 14a and across and into container 18 holding the neonate nutrition. By way of example and not limitation, it will be appreciated that heat transfer fluid 58, referred to in the embodiments described herein, could be replaced by various aqueous solutions, or by an appropriate oil such as mineral oil or silicon oil or that a heat transmitting solid such as sand or sodium chloride could be substituted for heat transfer fluid 58. The only object being that the heat generated by heating unit 52 be swiftly and consistently transferred into the contents of container 18. To this end, it, of course, will be appreciated, that a transfer fluid as opposed to a transfer solid or semi-solid is most easily used for such a situation and an inexpensive fluid, such as water, is likely the fluid of choice.

Still referring to FIGS. 4 and 5, bag 16 may be made from any pliable or flexible plastic the specifics of which are well known to those skilled in the art. Polyethylene bags, for example, may be used for bag 16. The bag of the embodiment shown in FIG. 4 is provided with a generally tapered or frusto-conical sidewall shaping. It will be appreciated that reservoir or well 14a of one embodiment described herein is provided with a similar conical or frusto-conical tapering of the sidewalls 68 (FIG. 2) of wells 14a-14d, and that a similar tapering is provided to the continuous sidewall 70 of bag 16. The tapering of sidewall 70 of bag 16 to generally match the tapering of sidewall 68 of well 14a allows for close contact between bag 16 and well 14a thereby enabling efficient transfer of heat from well 14 to heat transfer fluid 58.

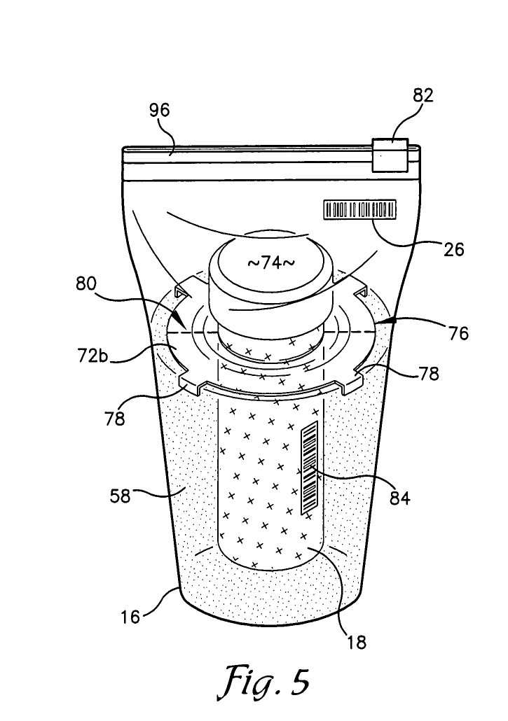

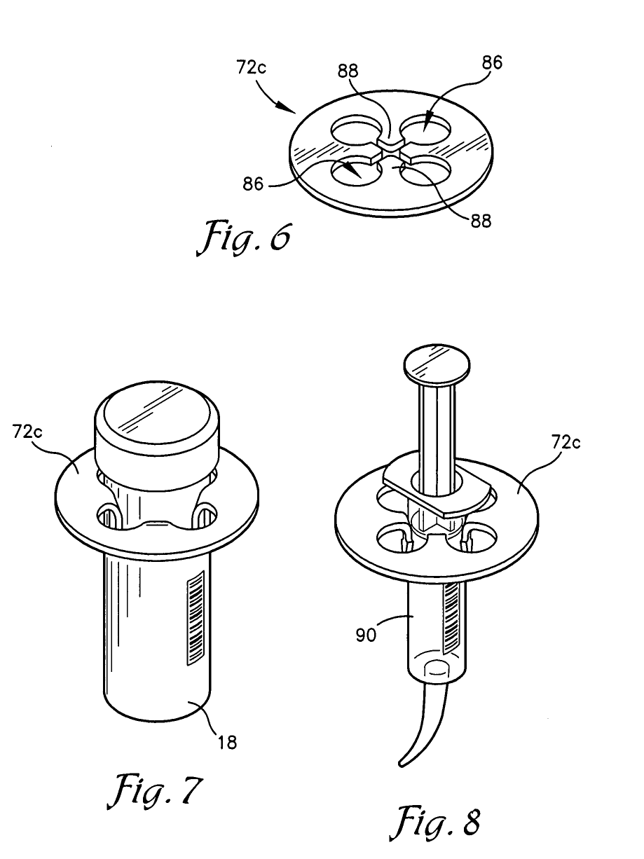

Examination of bag 16 of FIGS. 4 and 5 shows that two different embodiments of a collar 72 are shown in FIGS. 4 and 5. A third collar embodiment is shown in FIGS. 6, 7 and 8. While various collar embodiments are shown in FIGS. 4-8, the operation of collar 72a (FIG. 4) and collar 72b (FIG. 5) and collar 72c (FIG. 6) are similar. In operation, the collar embodiments 72a, 72b and 72c operate to hold or suspend container 18 within heat transfer fluid 58 which is held within bag 16. Collar 72 is provided to maintain closure 74, which covers the opening into container 18, spaced above the surface of heat transfer fluid 58 to thereby avoid any contact of closure 74 or the opening of container 18 with heat transfer fluid 58 while container 18 is within bag 16 and in contact with heat transfer fluid 58. This separation of closure 74 and the opening of container 18 from heat transfer fluid 58 is desirable for sanitary reasons. The spacing ensures that non-sterile and possibly contaminated fluids do not come into contact with surfaces which may be contacted by the mouth of the neonate. The construction of collar 72a, 72b and 72c may be such that container 18 is allowed to float on the surface of heat transfer fluid 58 where the weight of the contents of container 18 allows for buoyancy. But it is a principle feature of collar of 72a, 72b and 72c that the collar contact sidewall 68 of reservoir or well 14a-14d in a frictional fit manner so collar 72 is supported by sidewall 68 of wells 14a-d to maintain closure 74 of container 18 and the opening into container 18 spaced above the surface of heat transfer fluid 58 when bag 16 having fluid 58 and container 18 therein is inserted into well 14. Collar 72a (FIG. 4) is provided with a generally smooth outer perimeter 76 which is sized to seat within well 14a and to contact sidewall 68 of well 14a to support container 18 and closure 74 above the surface of heat transfer fluid 58. It will be appreciated that where container 18 and its contents are sufficiently buoyant within heat transfer fluid 58 that collar 72a, 72b and 72c will serve to provide a stabilizing aspect to container 18 as it floats in heat transfer fluid 58 and thereby preventing tilting of container 18 which might bring closure 74 or the opening of container 18 into contact with heat transfer fluid 58.

Referring now to FIG. 5, collar 72b is shown inserted and welded within bag 16. Collar 72b is an embodiment having standoff flanges or welding flanges 78 extending from outer perimeter 76 of collar 72b. Flanges 78 are attached, by welding in a preferred embodiment, to sidewall 68 of well 14a-14d to provide support to container 18 held within collar 72b. Flanges 78 connect collar 72b to bag 16 while avoiding complete securing of outer perimeter 76 with bag 16 as this would inhibit the folding flat of the bag and collar assembly. A fold line 80 is provided in collar 72b which permits collar 72b to be folded in half thereby allowing for the complete collapsing of bag 16 for shipment and storage when heat transfer fluid 58 is not within bag 16. It will be appreciated by those skilled in the art that bag 16 is provided with a convenient seal mechanism, such as the sliding zipper-type closure 82 (FIG. 5), though any convenient means of sealing bag 16 may be used. It will also be appreciated that an adhesive seal may be preferred thereby providing a means of security to bag 16 which would evidence the improper opening of bag 16 by an unauthorized person after it has been properly sealed by neonate caregivers. An identifying indicia, such as bar code 26, also may be included on bag 16 to provide specific and/or unique identification of bag 16 and to associate bag 16 and its contents with a particular patient or neonate. A second indicia 84, which also may be a bar code, may be included on container 18 for separate tracking of container 18.

Referring now to FIGS. 6, 7 and 8, another embodiment of the collar 72 used to support container 18 within bag 16 is shown. Collar 72c of FIG. 6 is comprised of a disc having a plurality of voids therein and with a portion of the interstitial material between the voids removed to create flaps 88. As shown in FIG. 7, flaps 88 are flexible and allow the insertion of variously sized objects, such as container 18 (FIG. 7), and/or feeding syringe 90 (FIG. 8) into collar 72c. It will be appreciated by those skilled in the art that collar 72c is most beneficially made from a flexible plastic or rubber, such as neoprene or polyethylene or polypropylene which is selected to provide a sufficient degree of flexibility so that variously sized objects may be supported within collar 72c by flaps 88. In this manner, variously sized devices may be supported by collar 72c, as well as oddly or asymmetrically shaped devices. It should further be appreciated that the materials for a construction of collar 72a and/or 72b may be less flexible than the most desirable materials used to construct collar 72c By contrast, collar 72a and 72b do not require the degree of flexibility which is desirable for flaps 88 of collar 72c, rather, collars 72a, 72b may be of a more rigid nature as they are generally designed to accommodate the particular container size 18 being employed by the user of device 10.

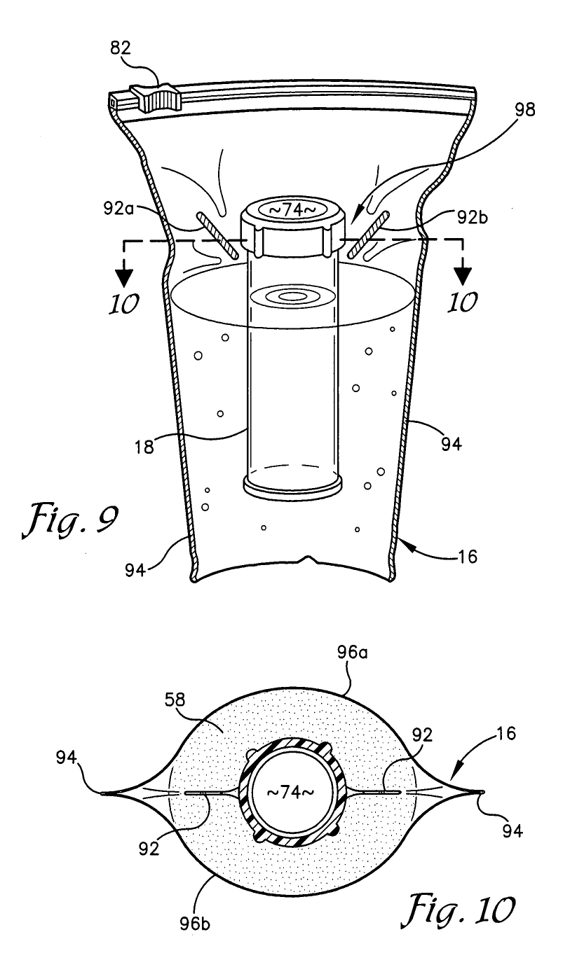

Referring now to FIG. 9, another embodiment of bag 16 is shown in which closure 74 is retained above the surface of fluid 58 by the inclusion of a restriction in the opening provided within bag 16. The restriction or stricture is formed within the interior of bag 16 by spot-welding together first and second welds or weld areas 92a, 92b of front wall 96a (FIG. 10) to rear wall 96b (FIG. 10) of bag 16. It is important that the welds 92a, 92b be sufficiently spaced apart to allow container 18 to be inserted between welds 92a, 92b, but sufficiently closely spaced to capture closure 74 on container 18 to thereby capture container 18 and retain closure 74 spaced from heat transmitting fluid 58. Therefore, it will be appreciated that to achieve this configuration that welds 92a, 92b are positioned as to be bilaterally spaced apart, generally, from the vertical center of bag 16 and the welds are sufficiently spaced above the bottom of bag 16 to allow closure 74 to be above the heat transmitting fluid 58 when the closure is captured between welds 92a, 92b.

The bag shown in FIGS. 9 and 10 is comprised of a typical plastic bag which typically is made of polyethylene or other appropriate flexible material and which has a front wall 96a sealed to a rear wall 96b at edges 94 to form a bag interior for holding contents therein. The top portion of bag 16 is closed by a zipper-type closure 82 which is well-known in the art. The embodiment of FIG. 9 is adapted to retain closure 74 with container 18 above the surface of fluid 58 which has been introduced into bag 16 to provide a heat transfer medium for warming of a nutritional solution which is within container 18. As previously remarked, it is preferred to maintain the opening of container 18, as well as closure 74 spaced above heat transfer fluid 58 for sanitary purposes. The embodiment of FIG. 9 accomplishes this by inclusion of weld points 92a, 92b which serve to hold together or connect a portion of front wall 96a to a portion of rear wall 96b to create an open area 98 therebetween. Open area 98, which constitutes the opening between weld 92a and weld 92b, is of a reduced diameter as compared to the overall diameter of bag 16 and it is, in general, of sufficient size to permit the passage of container 18 there through while restricting the passage of closure 74 there through. In this manner, when bag 16 is supported in an upright fashion, either by a user grasping the upper edge of bag 16 adjacent to closure 82, or by inserting bag 16 into any of wells 14a-14d, closure 74 is maintained spaced from fluid 58 and contamination of closure 74 and the opening of container 18 (not shown) is avoided.

In FIG. 10, a cross-section view, taken along line 10-10 of FIG. 9, shows the constriction of bag 16 at welds 92a, 92b which serves to prevent the passage of closure 74 past the welds 92a, 92b while allowing the container 18 to pass downwardly between the welds and into the heat transmitting fluid 58.

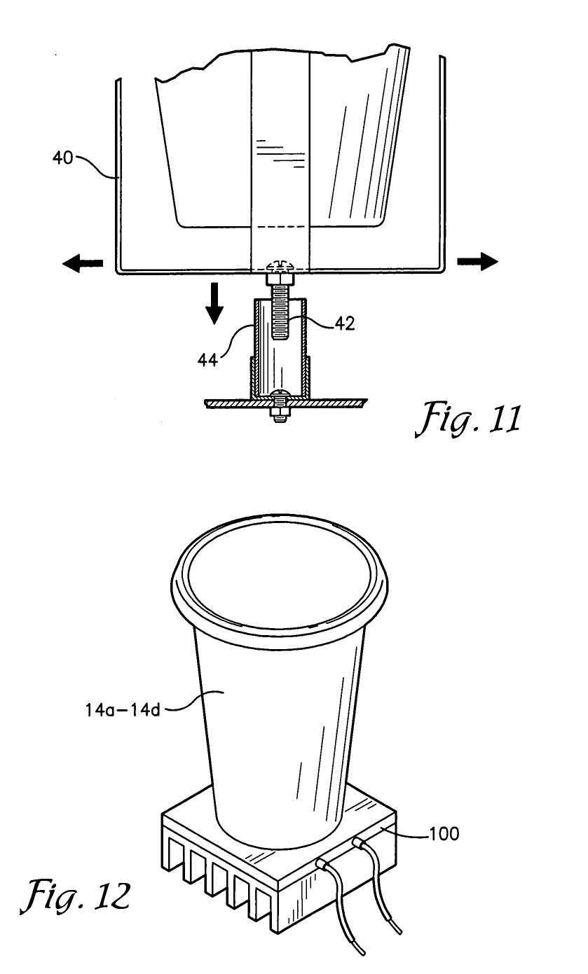

Referring now to FIG. 11, an alternate mounting of well 14a-14d is shown wherein a screw or post 42 extending from securing frame 40 extends into a tube acting as support 44. The tube-type support functions to restrict the side-to-side movement of frame 40 during the operation of vibration device 46.

In FIG. 12 and alternate device for heating and cooling well 14a-14d is shown. A peltier thermoelectric module 100 operating on 12 volts direct current is mounted in contact with well 14a-14d. Peltier modules are semi-conductor elements which allow cooling, heating and temperature regulation through direct current electricity. By putting a direct current through a peltier module, a temperature difference develops on the sides of the unit. The low temperature side absorbs heat, and the high temperature side radiates heat, transferring heat from the low to the high temperature side of the peltier module. By changing the polarity of the current, the direction of heat flow can be changed. Also, by altering the size of the current it is possible to change the amount of heat transfer. By connecting a peltier module 100 to a metallic well 14a-14d a single structure can be used to heat and cool the contents of well 14a-14d. It will be appreciated by those skilled that the peltier module 100, which is described above as a block that is mounted in contact with well 14a-14d, could be constructed as the well 14a-14d itself. In this embodiment the well 14a-14d is actually constructed as a peltier module 100 and therefore the heating and cooling of heat transfer fluid or material 58 can be accomplished by the well 14a-14d which is capable of producing heating or cooling itself.

### Formula Direct Temperature Detection

One drawback of the previous systems for formula warming is the accurate determination of temperature-warming endpoints and temperature monitoring generally. This is a result of the indirect determination of the actual temperature of the breast milk or formula. In previous systems temperature determination often has been based on assumptions and the timing of applied heating based on the generalized starting point temperature of the breast milk or formula (i.e., frozen or room-temperature starting temperature of the breast milk or formula). This drawback is overcome by one of the several embodiments for making direct temperature measurement of the breast milk or formula described below. In general, these embodiments employ the use of direct temperature measurement by infrared temperature detection of the temperature of the breast milk or formula. Alternatively, the direct temperature measurement of the breast milk or formula can be achieved by inclusion of a radio frequency reporting temperature sensor within the breast milk or formula such as a radio frequency identification device (RFID) having a temperature tracking or monitoring capability.

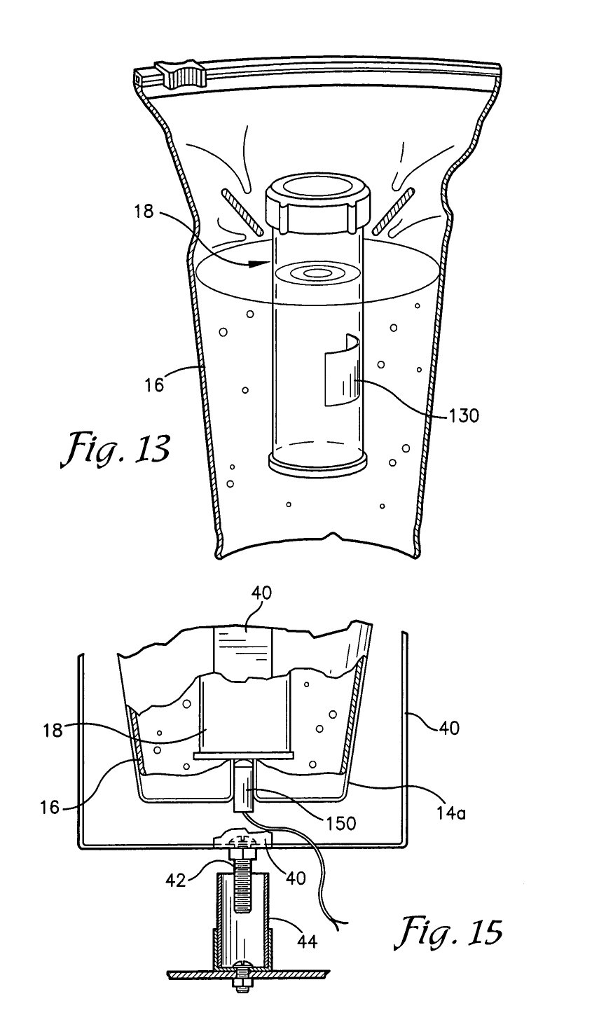

Referring to FIG. 13, a radio frequency identification device (RFID) 130 having a temperature tracking or monitoring capability is shown included within the breast milk or formula in container 18. The RFID device can be used to repeatedly detect the temperature of the breast milk or formula as the temperature of the breast milk or formula is increased or held static by the warmer device 10 (FIG. 1) or during storage in a refrigerator or during transport between the storage area and the warmer or the warmer and the neonate or mother prefatory to feeding.

One such RFID tag or RFID device 130 for inclusion with the breast milk or formula or for attachment to the wall of the container 18 is the Log-ice Temperature Tracker which is produced by Intelligent Devices, Inc., of Suwanee, Ga. The Log-ic device allows temperature monitoring over time and weighs less than 1 oz. The size of the Log-ic device is approximately 2 inches square with a thickness of about 0.1 inches. The Log-ic is a flexible RFID sensor tag capable of processing up to 64,000 temperature readings. It can be calibrated for a temperature sensitivity of from ±0.1 to ±1° Celsius. The device is available both as single use disposable device as well as re-usable versions.

The Log-ic® tag can be programmed and its data collected by use of a CertiScan® wireless 13.56 MHz RFID solution also available from Intelligent Devices, Inc. A handheld data collection device can be used to monitor tags 130 on containers 18 as they are found in the neonate ward in various locations such as in the freezer or refrigerator or in the warmers on a transport cart or within the neonate nursery. The tags 130 can be kept in inventory in a power conserving “sleep” mode until they are required for use. The tag 130 is activated by pushing a button on the tag to begin the temperature monitoring of the contents of the container 18.

The tags 130 are capable of receiving programmable temperature thresholds via two-way radio frequency communication. The tag 130 can be programmed so that should a temperature fault occur during the handling of the breast milk or formula (for example, a temperature that is out of the acceptable temperature range is reached for a time greater than 5 minutes) the tag is programmed to display a warning light to the end user that a temperature fault condition was reached.

The tags 130 do not have to be removed from the container 18 to capture their data. This saves time and maintains the ability to keep the breast milk or formula isolated within the container 18 until use. The tag data can be constantly downloaded via the wireless CertiScan RFID reader during the entire time the breast milk is being held in container 18 to ensure that proper temperature and handling always is maintained. Since the tag 130 can perform up to 64,000 readings the quality and safety of the breast milk can be tracked, verified and documented without active human contact with the breast milk or formula.

### Direct Temperature Detection Via Infrared Radiation Pyroelectric Sensors

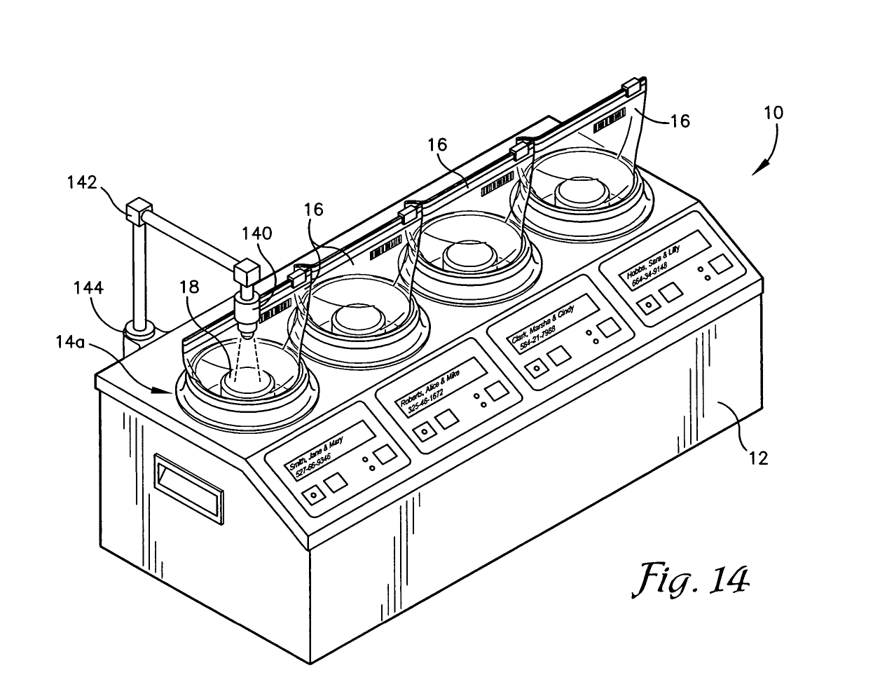

Referring now to FIGS. 14 and 15 two embodiments of an infrared radiation (IR) pyroelectric sensor are shown for direct measurement of the temperature of the neonate formula or breast milk contained in the container 18. The pyroelectric sensor is used to detect infrared radiation that is emitted by the neonate formula or breast milk as it is warmed in the container 18. Such sensors are known to those skilled in the art.

In general, pyroelectric sensors are made of a crystalline material that generates a surface electric charge when exposed to heat in the form of infrared radiation. When the amount of radiation striking the crystal changes, the amount of charge also changes and can then be measured by a field-effect transistor (FET) sensor. Pyroelectric sensors can be made from lithium tantalate (LiTaO3) which generates electric charges with small temperature changes. These sensors are small, stable, uniform and durable and thus well suited to a high use environment such as a hospital.

In the embodiment of FIG. 14, the IR sensor 140 is suspended over the container 18. The top or cap of container 18 has been constructed from an infrared transparent material so as not to interfere with temperature reading. A telescoping and rotateable arm 142 mounted in holder 144 is used to suspend the IR sensor 140 over the container 18 and can be used to rotate sensor 140 out of the way when the container 18 is inserted into or removed from the warmer 10.

In the embodiment of FIG. 15, the IR sensor 150 is inserted into the bottom of each well 14. In this manner the IR sensor 150 makes direct contact with bag 16 and the container 18 inside the bag as both are suspended in well 14. In this manner detection of the temperature of the heat transfer fluid 58 is avoided. An infrared detector suitable for this purpose is sold by Raytek Corporation of Santa Cruiz, Calif. The Raytek model CI1A having a J thermocouple output has an overall temperature detection range of 0° C. to 115° C. (32° F. to 240° F.). As can be appreciated by examination of FIG. 15, infrared sensor 150 extends upwardly into well 14 and the bottom of bag 16 and the bottom of container 18 contact sensor 150. This direct contact is intended to exclude heat transfer fluid 58 so that the temperature of heat transfer fluid 58 does not affect the reading obtained by sensor 150. It also will be appreciated that the material used to construct the bottom of container 18 must be infrared transparent to properly permit sensor 150 to detect the infrared radiation being emitted by the breast milk or formula within container 18 as it is warmed by heat transfer fluid 58.

Thus, in the operation of the embodiments of FIGS. 14 and 15, the infrared detector or sensor 140, 150 generates an electric charge when exposed to heat in the form of infrared radiation. The amount of charge generated is in relation to the temperature of the breast milk or formula held in container 18. The detected charge is converted into a direct, actual temperature reading of the breast milk or formula held in container 18. Further, it will be appreciated by those skilled in the art that in the embodiment of FIG. 15 having an infrared sensor that extends upwardly from the bottom of well 14a-14d that the container 18 (with or without bag 16) could be supported directly on sensor 150 thereby eliminating the need for use of collar 72. In the alternative a similar standoff structure could be provided to support container 18 by inserting a standoff or magnetic standoff which may be of various convenient heights into well 14a-14d to maintain container 18 above the fluid 58 level and thereby avoid the use of collar 72.

Yet another embodiment that can be employed based on the structure shown in FIG. 15 is the use of a thermocouple to directly measure the temperature of the fluid in container 18. In this embodiment a thermocouple in a suitable prong-like or spike structure extends upwardly from the bottom of well 14a-14d in a manner similar to that shown in FIG. 15. The container 18 is provided with an invagination in the bottom of container 18 that is sealed by a grommet or septum against the intrusion of heat transfer fluid 58. Container 18 is then seated on the prong-like or spike structure containing a J thermocouple by inserting the prong-like or spike structure through the grommet or septum to place the thermocouple directly against the invagination of container 18 that is extending upwardly from the bottom of container 18 and into the center of container 18 so that the invagination is surrounded by the breast milk or formula being warmed.

### Portable Neonate Formula Warming

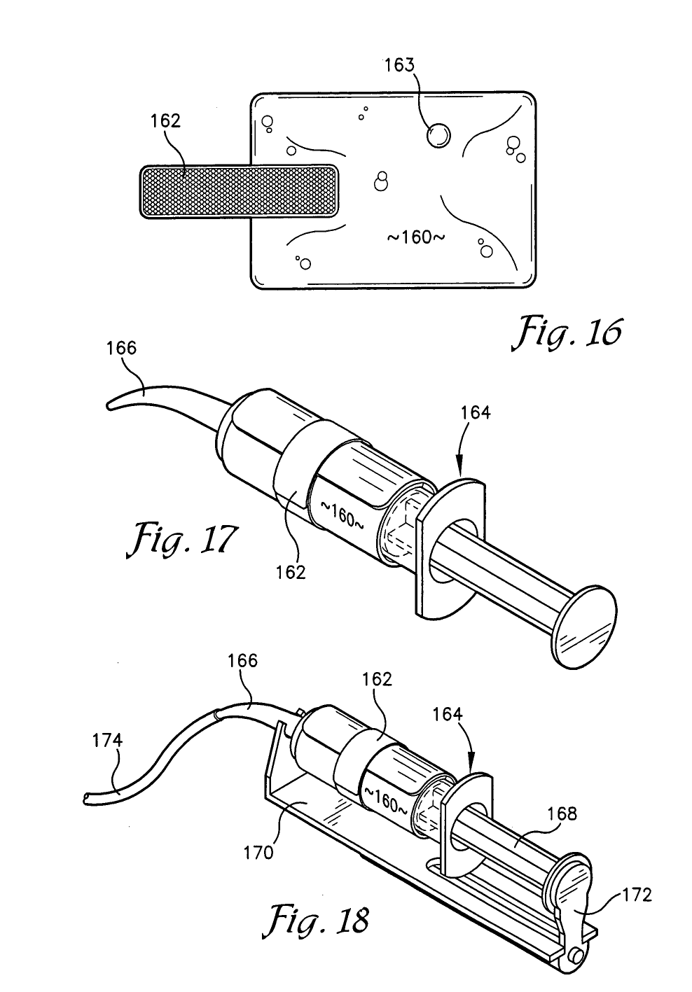

Referring now to FIGS. 16, 17, and 18 a portable warmer pouch or portable warmer device 160 is shown for use during transportation of a container 18 or dosing syringe 164 or for maintaining the temperature of a dosing syringe 164 while it is placed in a metered delivery system 170 for delivering breast milk or formula at a determined feeding rate (FIG. 18). The portable warmer device is essentially a pouch or a bag having a combination a materials therein which upon selectable activation produce an exothermic reaction usually by crystallization of a supersaturated solution contained within the bag. Typically, the activation is accomplished by including a nucleating agent or seed crystal within a holder 163 that is floating within the supersaturated solution of the bag or pouch or device 160. When it is desired to active the warming function of the bag or pouch or device 160 the holder 163 is broken or fractured and the nucleating agent or seed crystal within a holder 163 is released into the supersaturated solution and crystal formation begins within the supersaturated solution. The formation of the crystals results in heat being produced (an exothermic reaction) and this heat may then be applied to the object to be warmed.

One typical combination of materials which will produce an exothermic reaction within the temperature range desired for maintaining the proper temperature for breast milk for formula is a supersaturated solution of sodium acetate (NaC₂H₄O₂). A seed crystal is then introduced into this supersaturated sodium acetate solution upon demand. This on demand insertion of the seed crystal is produced by snapping the disk 163 which is situated within package or pouch 160 and in contact with the sodium acetate solution. The introduction of the seed crystal initiates a chain reaction causing the supersaturated solution to crystallize. The crystallization process of the supersaturated solution is an exothermic reaction and produces heat within a temperature range sufficient to warm and maintain warmth of the breast milk or neonate formula which is contained within a container, 18, or a syringe type container, 160. When the seed crystal is introduced into the supersaturated sodium acetate solution crystals of sodium acetate begin to form and produce a release of energy or exothermic reaction and the solution temperature elevates and begins approaching the “freezing point” of sodium acetate (192° F.).

Other alternative agents are available that may be used to produce the desired exothermic reaction of the crystallization of the supersaturated solution. For example, Disodium Phosphate (12 Hydrate) (Na₂HPO₄12H₂O) having a melting point temperature of 36° C. (96.8° F.) (also known as Sodium Phosphate Dibasic Dodecahydrate and/or Disodium hydrogenphosphate Dodecahydrate) may be used with a nucleating agent comprised of borax or carbon or Titanium Dioxide (TiO₂) or copper or aluminum provided as part of nucleating device 163 (FIG. 16) to initiate the crystallization reaction of the supersaturated solution of Disodium Phosphate (12 Hydrate). Alternatively, Sodium Thiosulfate (NaS₂O₃.5H₂O) having a melting point of 57° C. (134.6° F.) may be used with a nucleating agent comprised of potassium sulfate or tetrasodium pyrophosphate to initiate the crystallization reaction of the supersaturated solution of sodium thiosulfate. As mentioned previously, sodium acetate (NaCH₃CO₂3H₂O) (sodium acetate trihydrate) having a melting point of 46° C. (114.8° F.) may be used to form the supersaturated solution with nucleating agents such as strontium sulfate or carbon or sodium sulfate.

In operation, and still referring to FIGS. 16, 17 and 18, the portable warming pouch 160 (FIG. 16) may be applied to container 18 or syringe 164 by first activating the nucleating agent that's in nucleating agent 163 to begin the crystallization reaction and then wrapping the flexible bag or pouch 160 around the exterior surface of container 18 or syringe 164.

It will be appreciated that the temperature achieved by portable warming pouch 160 will be determined by the type of solution with which bag 160 is filled. Different solutions will produce different temperatures and therefore the user will wish to select the temperature most appropriate to the particular situation and the length of time over which warming must continue. It will also be appreciated that warming pouch 160 may be used in conjunction with an RFID device having a temperature sensing unit therein to permit the monitoring of the temperature to be conducted while the portable warming pouch or bag 160 is being applied to container 18 or syringe 164. As shown in FIG. 17, an activated warming device or pouch 160 has been applied to 164 and is held in place by the use of Velcro or adhesive strap 162. With warming bag or pouch 160 in place, the syringe can be carried to a feeding location without a reduction in temperature and can be used to feed a neonate over a period of time by extruding the breast milk or formula contained in syringe 164 out of nozzle 166 by application of plunger 168.

Referring now to FIG. 18, the situation frequently arises in the feeding of neonates during which syringe feeding must take place and the formula must be dispensed over a lengthy period of time. In these types of situations, a metered feeding device 170 is used to slowly extrude breast milk or formula from a syringe 164. As shown in FIG. 18, a typical syringe 164 has been inserted into a metered feeding device 170 having a retractable arm 172 in contact with plunger 168 of syringe 164. During a selected time period, the retractable arm 172 compresses against plunger 168 driving it into syringe 164 to extrude a metered quantity of breast milk or formula from syringe 164 through nozzle 166 and out of feeding tube 174. It will be appreciated that such metered feedings will take place over a substantial segment of time during which the contents of syringe 164 can cool. This cooling of the contents of syringe 164 is alleviated by the application of portable warming pouch 160 to syringe 164 as shown in FIG. 18. As previously described, for FIG. 17, the pouch 160 is wrapped about syringe 164 after activation of the solution by the use of nucleating agent 163 to initiate the exothermic crystallization reaction within pouch 160.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Certain changes may be made in embodying the above invention, and in the construction thereof, without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive neonate nutrition warming device and bag and collar for warming formula and nutritional media for babies are constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

Having thus described the invention what is claimed as new and desired to be secured by Letters Patent is as follows:

1. An apparatus for warming a heat transmitting fluid to warm a neonate nutrition within a container having a closure thereon, the apparatus comprising:
a liner for holding the heat transmitting solution,
a collar means for insertion into said bag said collar supporting the container to space the container closure above the heat transmitting solution,
a well for receiving therein said bag and said collar said well having a sidewall for supportably seating said collar therein, and
a heating device attached to said well to heat said well and the heat transmitting solution to warm the neonate nutrition within the container.

2. The apparatus as claimed in claim 1 wherein the collar supports the container by the collar being buoyant in the heat transmitting solution.

3. The apparatus as claimed in claim 1 wherein the liner is a flexible plastic bag.

4. The apparatus as claimed in claim 1 further comprising a vibration means connected to said well to shake said well and said heat transmitting solution for circulation of the heat transmitting solution and the neonate nutrition.

5. The apparatus as claimed in claim 1 wherein said collar means is removable from said bag.

6. The apparatus as claimed in claim 1 wherein said collar means is attached to said bag.

7. The apparatus as claimed in claim 1 wherein said collar is generally ring-shaped structure having a generally central void for receiving the container.

8. The apparatus as claimed in claim 1 further comprising a thermostatic sensor for controlling the temperature of said heat transmitting solution.

9. The apparatus as claimed in claim 4 further comprising a housing for supporting said well and a cuff connected between said housing and said well to dampen transmission of motion from said vibration means to said housing.

10. The apparatus as claimed in claim 1 further comprising an infrared temperature sensor for detecting the temperature of said neonate nutrition.

11. The apparatus as claimed in claim 10 wherein said infrared temperature sensor is connected to a bottom surface of said well for contacting said container for detecting the temperature of the neonate nutrition.

12. The apparatus as claimed in claim 1 further comprising a radio frequency identification device for insertion into the container, said identification device having a temperature sensor for detecting the temperature of the neonate nutrition.

13. A bag for holding a heat transmitting solution and a neonate nutrition container, the container having an opening with an openable closure connected thereto, the apparatus comprising:
a flexible bag having a continuous sidewall for receiving therein the heat transmitting solution and the container,
a collar means within said bag said collar being attachable to the container to support the container within the bag and to maintain the container opening and closure spaced above the heat transmitting solution.

14. The bag as claimed in claim 13 wherein said collar is generally ring-shaped and having a generally central void for receiving the container therein.

15. The bag as claimed in claim 13 wherein said collar has generally ring-shaped perimeter with a central void therein and a plurality of flexible flaps extending inwardly from said perimeter into said void for support of the container inserted into said void.

16. The bag as claimed in claim 13 wherein said collar further comprises a plurality of flanges extending from an outside perimeter of said ring for supporting said ring within a well contacting said bag and the sidewall of a well for supportably

17. The bag as claimed in claim 13 further comprising an identifying indicia.

18. The bag as claimed in claim 13 further comprising a resealable closure.

19. The bag as claimed in claim 13 further comprising a non-resealable security closure for indicating tampering.

20. An apparatus for warming a heat transmitting solution used to warm neonate nutrition within a container, the container having an opening with an openable closure thereon, the apparatus comprising:
a bag for holding the heat transmitting solution, and
a collar means connected to said bag said collar supporting the container to space the container closure above the heat transmitting solution.

21. The bag as claimed in claim 20 wherein said collar further comprises a plurality of flanges extending outwardly from an outside perimeter of said ring for supporting said ring within a well contacting said bag and the sidewall of a well for supportably

22. An apparatus for warming a heat transmitting solution by a heated well said well having a sidewall, the heat transmitting solution warming neonate nutrition solution within a container, the container having an opening with an openable closure thereon, the apparatus comprising:
a bag for holding the heat transmitting solution, said bag having a wall shape that is generally shaped to conform to the sidewall shape of the well, and
a collar means insertable in said bag, said collar having a void therein for receiving a container having a neonate nutrition solution therein, the collar supporting the container to space the container closure above the heat transmitting solution.

23. The apparatus as claimed in claim 22 wherein said collar further comprises a plurality of flanges extending outwardly from an outside perimeter of said collar said flanges supportively holding said collar in contact with the sidewall of the well.

24. A collar for supporting a container in a fluid, the collar comprising:
a generally ring-shaped disk having an inner perimeter defined by a central void,
a plurality of flexible flaps extending inwardly from said perimeter into said void for support of the container inserted into said central void.

25. An apparatus for holding a heat transmitting solution for transfer of heat from the heat transmitting solution to a neonate nutrition within a container, the container having an opening with an openable closure thereon, the container being situated within the heat transmitting solution, the apparatus comprising:
a bag for holding the heat transmitting solution, said bag having first and second opposed sides said sides having sealed perimeter edges including a bottom perimeter edge and an openable top edge,
a fill line on said bag for indicating a volume of the heat transmitting solution to be contained in said bag, and
a collar means comprising a first weld point and a second weld point on said bag first side to connect said first side to said second side said first and second welds being bilaterally spaced from a mid-point of the said bag first side said bilateral spacing being sufficient spaced apart to allow capture of the container therebetween and said first and second welds being sufficiently spaced from said bottom perimeter edge to support said container above the heat transmitting solution when the heat transmitting solution is added to said fill line.

26. A portable apparatus for warming a neonate nutrition within a container during transport of the container, the apparatus comprising:
a flexible, sealed pouch having a retaining strap connected thereto for connecting said pouch to a container having a neonate nutrition therein,
a supersaturated solution of a solute in a solvent the solution being contained within said pouch, said supersaturated solution providing an exothermic crystallization reaction upon the initiation of crystallization of said solute, and
a seed crystal for initiating said exothermic crystallization reaction, said seed crystal being contained in a holder suspended in said solution for delivery of said seed crystal into said solution upon rupturing of said holder.

27. The apparatus as claimed in claim 26 wherein said container is a neonate feeding syringe.
